(19) United States
(12) Patent Application Publication
(10) Pub. No.: US 2021/0238449 A1
(43) Pub. Date: Aug. 5, 2021

(54) Thermally Degradable Adhesives with Cellulose, and Related Methods of Manufacture and Use

(71) Applicant: NATIONAL RESEARCH COUNCIL OF CANADA, Ottawa (CA)

(72) Inventors: Andrew Myles, Edmonton (CA); Rongbing Du, Edmonton (CA); LE Jonathan, Edmonton (CA)

(21) Appl. No.: 16/327,082

(22) PCT Filed: Aug. 21, 2017
(86) PCT No.: PCT/IB2017/055035

§ 371 Date: Feb. 21, 2019

Related U.S. Application Data
(60) Provisional application No. 62/378,000, filed on Aug. 22, 2016.

(51) Int. Cl. C09J 5/06; C09J 163/04; C09J 101/02; C08K 7/02

(52) U.S. Cl. CPC C09J 5/06; C09J 163/04; C08K 2201/011; C08K 7/02; C09J 101/02

(57) ABSTRACT

A method includes heating an adhesive, which secures adjacent parts together and contains one or both of cellulose micro or nanocrystals, to a temperature sufficient to irreversibly degrade the adhesive and separate the adjacent parts. A thermally degradable composition has an adhesive; and one or both of cellulose micro or nanocrystals. A method of making a thermally degradable composition includes forming a thermally degradable composition by mixing the first part and the second part of the epoxy along with cellulose micro or nanocrystals.

### TECHNICAL FIELD

This document relates to thermally degradable adhesives containing cellulose, and related methods or making and using same.

### BACKGROUND

An adhesive, such as a glue, cement, mucilage, or paste, is a substance applied to contact surfaces to bind them together and resist separation. The use of adhesives offers advantages over binding techniques such as sewing, mechanical fastening and thermal bonding. Such advantages may include the ability to bind different materials together, to distribute stress more efficiently across the joint, ease of mechanization, improved aesthetics, and increased design flexibility.

Adhesives may be categorized by the method of adhesion, such as the formation of chemical bonds between substrate and adhesive, electrostatic forces, van der Waals forces or a moisture-driven diffusion into the substrate followed by hardening. Adhesives may also be categorized into reactive and non-reactive adhesives, such as drying adhesives, pressure-sensitive adhesives, contact adhesives, hot adhesives, multi-part adhesives, and one-part adhesives. Adhesives may also be categorized by whether the raw stock is of natural or synthetic origin, or by initial physical phase. Adhesives may be thermally degradable.

Some adhesives, however, can prove difficult or impossible to thoroughly remove post-application without damaging the underlying substrate. For some adhesives, separation of adhered surfaces is possible by heating the adhesive above its melting temperature and separating the surfaces while still hot. However, this may require increased operator time, may cause damage to the adhered surfaces, and may lead to residue on the previously adhered surfaces.

### SUMMARY

In one aspect, the present application provides a method comprising heating an adhesive, which secures adjacent parts together and contains one or both of cellulose micro or nanocrystals, to a temperature sufficient to degrade the adhesive; and separating the adjacent parts. In one embodiment, the method further comprises allowing the adhesive to cool to a temperature between 0 and 50° C., e.g. to room temperature, prior to separating the adjacent parts.

In another aspect, the present application provides a thermally degradable composition comprising an adhesive; and one or both of cellulose micro or nanocrystals. In one embodiment, the thermally degradable composition has a cellulose micro or nanocrystals a concentration of at least fifteen percent by weight.

In another aspect, the present application provides a kit for forming the thermally degradable composition as described herein, the kit comprising the first part and the second part of the epoxy, and cellulose micro or nanocrystals, wherein the first part and the second part of the epoxy are separate from each other, and wherein the cellulose micro and/or nanocrystals are a) separate from the first and second parts of the epoxy, orb) dispersed within one or both of the first part and the second part of the epoxy.

In another aspect, the present application provides a kit comprising a first part of an epoxy adhesive comprising an epoxide, a second part of an epoxide adhesive comprising a hardener, and a written matter describing instructions for combining the first and second parts to form an epoxy adhesive, wherein the first and second parts of the epoxy adhesive are separate, and wherein the cellulose microcrystals, cellulose nanocrystals, or both, are a) separate from the first and second parts of the epoxy adhesive, orb) dispersed within the first and/or second parts of the epoxy adhesive. In one embodiment, the written matter further describes instructions for degrading the formed epoxy adhesive by heating to a temperature between 200° C. and 300° C.

In some embodiments the technology is directed to an adhesive composition comprising a composite of an epoxy resin and a crystalline cellulosic material (e.g. nanocrystalline cellulose). The composition is thermally stable retaining good adhesive properties at a temperature less than about 180° C., while substantially degrading to a brittle, easily removed material at a temperature of about 220° C. or higher.

In various embodiments, there may be included any one or more of the following features: The adhesive comprises cellulose nanocrystals (CNCs). The cellulose micro or nanocrystals have a concentration of at least five percent by weight of the thermally degradable composition. The cellulose micro or nanocrystals have a concentration of between one and fifty percent by weight of the thermally degradable composition. The cellulose micro or nanocrystals have a concentration of at least fifteen percent by weight of the thermally degradable composition The cellulose micro or nanocrystals have a concentration of at least fifty percent by weight of the thermally degradable composition. Heating comprises heating to a maximum temperature of less than 300° C. to degrade the adhesive. Heating comprises heating to a maximum temperature of 250° C. or less to degrade the adhesive. Heating comprises heating to a maximum temperature of 220° C. or less to degrade the adhesive. Heating comprises heating to a temperature between 200° C. and 250° C. to degrade the adhesive. The adhesive does not degrade at a temperature of 180° C. The adhesive comprises an epoxy (although non-epoxy adhesives may be used). The epoxy is an end product of a two part polymerizable system comprising a first part containing epoxides and a second part comprising a hardener. The cellulose micro or nanocrystals are uniformly dispersed in the epoxy prior to heating. The epoxy is adapted to be stable at temperatures of 300° C. or higher when cured in pure form. The epoxy comprises the end product of reaction between a mixture of aliphatic amine, 1,2,3,6-tetrahydro-methyl-3,6-methano-phthalicanhydride, epichlorohydein and phenol formaldehyde novolac. Prior to heating, the epoxy and the cellulose micro or nanocrystals form a polymer matrix where the cellulose micro or nanocrystals form links in the polymer matrix, and in which heating is carried out to an extent sufficient to break the links, by cleavage of covalent bonds i) internal to the cellulose micro or nanocrystals or ii) at the interface between the cellulose micro or nanocrystals and the epoxy in the polymer matrix. After heating, removing the adhesive from the adjacent parts. Prior to heating, the adhesive is located within a threaded connection between the adjacent parts, which are parts of a downhole apparatus. The cellulose micro or nanocrystals comprise one or more of nanowhiskers, nanocrystalline cellulose, whiskers, nanoparticles, nanofibers, microcrystallites, or microcrystalline cellulose. The adhesive comprises cellulose nanocrystals (CNCs) The thermally degradable composition degrades at temperatures of less than 300° C., The thermally degradable composition degrades at temperatures of 250° C. or less. The thermally degradable composition degrades at temperatures of between 200 and 250° C. The thermally degradable composition is stable at a temperature of 180° C. A combination comprises the thermally degradable composition securing adjacent parts. The thermally degradable composition is located within a threaded connection between the adjacent parts, which are parts of a downhole apparatus. Applying the thermally degradable composition to secure adjacent parts together. Prior to forming the thermally degradable composition, dispersing the cellulose micro or nanocrystals within the second part.

These and other aspects of the device and method are set out in the claims, which are incorporated here by reference.

### BRIEF DESCRIPTION OF THE DRAWINGS

Embodiments will now be described with reference to the figures, in which like reference characters denote like elements, by way of example, and in which:

FIG. 1 is a flow diagram depicting a method of making, applying, and removing a thermally degradable adhesive.

FIGS. 1A and 1B are top plan and side elevation views, respectively, of a pair of steel plates and adhesive used in testing some of the thermally degradable compositions disclosed here.

FIG. 2 is a graph illustrating the shear strength of epoxy 526 adhesion specimens cured at 90° C. for 1 h and 150° C. for 8 h.

FIG. 3 is a graph illustrating the shear strength of epoxy 526 adhesion specimens cured at 90° C. for 1 h and 150° C. for 8 h, and baked at 200° C. for another 1 h.

FIG. 4 is a graph illustrating the shear strength of epoxy 526 adhesion specimens cured at 90° C. for 1 h and 150° C. for 8 h, and baked at 250° C. for another 1 h.

FIG. 5 is a graph illustrating the shear strength of epoxy 526 adhesion specimens containing 5% wt. CNC cured at 90° C. for 1 h and 150° C. for 8 h.

FIG. 6 is a graph illustrating the shear strength of epoxy 526 adhesion specimens containing 5% wt. CNC cured at 90° C. for 1 h and 150° C. for 8 h, and baked at 250° C. for another 1 h.

FIG. 7 is a graph illustrating the shear strength of epoxy 526 adhesion specimens containing 50% wt. CNC cured at 90° C. for 1 h and 150° C. for 8 h.

FIG. 8 is a graph illustrating the shear strength of epoxy 526 adhesion specimens containing 50% wt. CNC cured at 90° C. for 1 h and 150° C. for 8 h, and baked at 200° C. for another 1 h.

FIG. 9 is a graph illustrating the shear strength of epoxy 526 adhesion specimens containing 50% wt. CNC cured at 90° C. for 1 h and 150° C. for 8 h, and baked at 250° C. for another 1 h.

FIG. 10 is a bar graph illustrating a comparison of lap shear results between specimens tested.

### DETAILED DESCRIPTION

Immaterial modifications may be made to the embodiments described herein without departing from what is covered by the claims.

Cellulose micro or nanocrystals, or both are used in various thermally degradable compositions and related methods. Cellulosic material such as cellulose nanofibers, nanocrystalline cellulose, and microcrystalline cellulose may be used, including modified celluloses, for example functionalized celluloses.

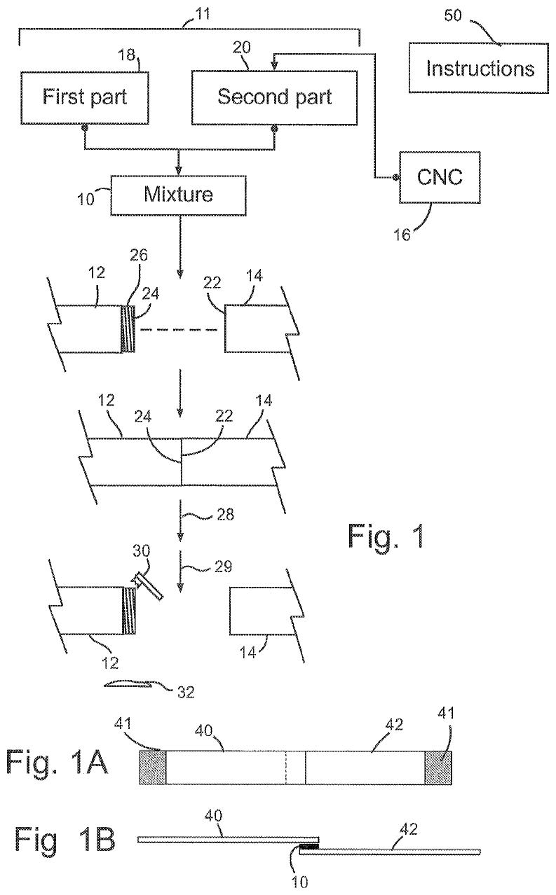

Referring to FIG. 1, a thermally degradable composition 10 comprises a suitable adhesive, such as one of the adhesives disclosed herein, and one or both of cellulose microcrystals or cellulose nanocrystals. Combining cellulose micro or nanocrystals with an adhesive may provide a composite that is thermally stable within a suitable range of operating temperatures specific to a particular application or applications of use, but that degrades above a predetermined threshold temperature. Degradation may refer to an irreversible change in composition that results in a reduction or loss of adhesive strength to a sufficient extent that adjacent parts 12, 14 secured by the adhesive may be separated without damaging the parts. Degradation may be characterized by denaturing, decomposition, or disintegration of the adhesive composition. Degradation may encompass a reversible or irreversible reaction. In some embodiments a chemical reaction, and not a mere phase change, occurs in the composition causing a loss of adhesive strength sufficient to permit separation of the parts without damaging the parts. The compositions may also change consistency and/or rheology, permitting adhered surfaces to be separated and/or the composition to be removed. Degradation may also be defined as an irreversible loss of mass. For example, during the degradation process, evolution of gas phase particles may occur, for example carbon dioxide if an oxidation process takes place. The degradation process may reduce the composition to char. In some cases, a substantial or complete loss of adhesive properties is achieved.

The concentration of the cellulose micro or nanocrystals in the composition may be varied, for example to tune the threshold degradation temperature, or range of temperatures, of the composition. In some embodiments, the cellulose micro or nanocrystals have a concentration between one and sixty percent by weight of the thermally degradable composition, for example between fifteen and fifty percent. In some embodiments, the concentration of cellulose micro and/or nanocrystals can be below 60% wt., e.g. below 50% wt., and above 1% wt., above 5% wt., above 10% wt., above 15% wt., above 20% wt., above 25% wt., above 30% wt., above 35% wt., above 40% wt., or above 45% wt. In one case, the cellulose micro or nanocrystals have a concentration of at least fifteen percent by weight of the thermally degradable composition. In some cases, the cellulose micro or nanocrystals have a concentration of at least fifty percent. In some embodiments, it was discovered that increasing the concentration of cellulose nanocrystals caused a relatively greater loss of adhesive strength after degradation at the same temperature.

The threshold degradation temperature or the extent of loss of adhesive strength after degradation may be tailored by adjusting the amount or type of cellulose micro or nanocrystals in the thermally degradable composition. The threshold degradation temperature may be defined as the temperature or range of temperatures above which degradation occurs. In some cases, the composition degrades at temperatures of less than 300° C. In other cases, the composition degrades at temperatures of 250° C. or less. In further cases, the composition degrades at temperatures of between 200° C. and 250° C., for example between 220-250° C. To ensure sufficient degradation the composition may be heated above the temperature at which degradation begins to occur, for example 20° C. above the base threshold degradation temperature. Below the threshold degradation temperature, the composition may be thermally stable. In some cases the composition may be stable (does not degrade) at a temperature of 180° C. In a further example the composition is stable at 180° C. but degrades above 200° C. The degradation temperature may be lower for the composition than either the cellulose micro or nanocrystals or adhesive in pure form under analogous conditions.

In some embodiments, the adhesive is maintained at a temperature above the degradation temperature for a duration of time sufficient to achieve the desired level of degradation, e.g. a level of degradation sufficient to separate adhered surfaces without damaging the surfaces. The adhesive may also be heated for a time sufficient to achieve a level of degradation sufficient to permit removal of the adhesive from the surfaces with damage. In some embodiments, the adhesive may be maintained above its degradation temperature for up to 10, up to 30, up to 60, up to 90, up to 120, or up to 150 minutes. Longer heating times may also be used as long as these do not cause substantial damage to the parts being adhered. In some embodiments, the adhesive may be maintained above its degradation temperature for a duration of from 10 to 150 minutes, for example from 30 to 90 minutes, or about 60 minutes.

Referring to FIG. 1, adhesive component 11 of the thermally degradable composition 10 may comprise an epoxy. Epoxy is a term used to denote both the basic components and the cured end products of epoxy resins. Epoxy resins, also known as polyepoxides, are a class of reactive prepolymers and polymers that contain epoxide groups. Epoxy resins may be reacted, for example, to form one or more of a chain or cross-link adjacent chains, either with themselves through catalytic homopolymerisation, or autocatalytic homopolymerisation, or with a range of co-reactants (also known as hardeners). A hardener is a compound that reacts with an epoxide to form a polymer by acting as a nucleophile to bond to and open the epoxide ring. Hardeners include polyfunctional compounds, such as polyamines (such as aromatic and aliphatic polyamines), acids, acid anhydrides, polyols (such as phenols), and polythiols. Monofunctional hardeners may be used. In some cases, the co-reactant is replaced with a form of radiation, such as ultraviolet radiation (UV), or heat, or with a mechanical element such as pressure.

The co-reactant or hardener may be referred to as a curative, and the linking reaction may be referred to as curing. Reaction of polyepoxides with themselves or with polyfunctional hardeners may form a thermosetting polymer. Epoxies may be characterized by relatively low shrinkage during curing, moisture resistance, adhesion to metal, resistance to thermal and mechanical shock, chemical resistance, and increased mechanical and fatigue strength when compared with conventional adhesives.

Several categories of epoxy resins include the glycidyl epoxy and non-glycidyl epoxy resins, although other epoxies may be used. Glycidyl epoxies may be categorized as glycidyl-ether, glycidyl-ester and glycidyl-amine. Non-glycidyl epoxies may be aliphatic or cycloaliphatic epoxy resins. Glycidyl epoxies may be prepared via a condensation reaction of appropriate dihydroxy compound, dibasic acid or a diamine and epichlorohydrin. Non-glycidyl epoxies may be formed by peroxidation of olefinic double bond. Glycidyl-ether epoxies such as, diglycidyl ether of bisphenol-A (DGEBA), bisphenol F, and novolac epoxy resins may be used.

Referring to FIG. 1, an epoxy 11 may be produced by mixing or otherwise combining a two part polymerizable system comprising a first part 18 containing epoxides and a second part 20 comprising a hardener. To form the adhesive composition 10, the cellulose micro or nanocrystals 16 may be combined with the epoxy 11 at a suitable part of the mixing or curing procedure. For example, the cellulose micro or nanocrystals are illustrated in FIG. 1 as being combined with the hardener prior to combining the hardener with the epoxide. The cellulose micro or nanocrystals may be pre-mixed with one or both of the first and second parts of the epoxy. In some cases, the cellulose micro or nanocrystals form a third part, and the first, second, and third parts are all combined together in a single mixing step, or the cellulose micro or nanocrystals are combined after mixing the first and second parts but prior to curing. In some cases, the adhesive component may be provided as a single component. The procedure of combining the cellulose micro or nanocrystals with the epoxy may be carried out to cause the cellulose micro or nanocrystals to be uniformly dispersed in the final cured epoxy.

The cellulose micro or nanocrystals may be sufficiently, for example uniformly, distributed or dispersed in the adhesive, or in a precursor thereof (e.g. a hardener) prior to combining the precursors. Dispersion may be achieved via a physical mixing process, such as by using one or more of a sonication device, kneading device, or a stirring device. In some cases, the cellulose micro or nanocrystals may be dissolved in the adhesive, or in a precursor (e.g. hardener liquid) thereof. If the cellulose micro or nanocrystals do not dissolve, then a suspending agent may be used. By dispersing the cellulose micro or nanocrystals in the precursor (e.g. hardener) prior to combining the first and second parts, the resulting mixture is more likely to achieve a uniform dispersion of cellulose micro or nanocrystals in the cured end product. In some cases the cellulose micro or nanocrystals are dispersed in the one of the first and second part that is less viscous, usually the part containing the hardener, as it may be relatively easier to disperse the cellulose micro or nanocrystals in a less viscous medium. The ability to adequately disperse the cellulose micro or nanocrystals in the adhesive was found to be a factor of viscosity, although other characteristics may be factors, such as solubility or functionalization of the cellulose micro or nanocrystals.

The step of mixing the first and second parts may also incorporate one or more of physical (for example stirring and/or sonication) and chemical (for example suspension and/or emulsion) mechanisms to ensure sufficient mixing. In cases where the first part is pre-mixed with cellulose micro or nanocrystals, the above dispersion mechanisms may be used to ensure sufficient dispersion. In some cases, both the first and second parts may be pre-mixed with cellulose micro or nanocrystals. The cellulose micro or nanocrystals may be pre-processed prior to mixing into the adhesive, for example by physically breaking up the crystals via a mechanical process such as one or more of sonication, sifting, and grinding. The first and second parts and cellulose micro or nanocrystals may be combined in layers or co-applied to create a layer upon application to a substrate. The parts and in some cases the cellulose micro or nanocrystals, may be combined by spraying together via a nozzle.

In some cases, a heat resistant (high temperature) epoxy is used, for example an epoxy that is adapted to be stable at temperatures of 300° C. or higher when cured in pure form. Heat resistant epoxies may be adapted to withstand temperature as severe as 300° C. and higher. Some heat resistant epoxies start to melt above 200° C., and some start to decompose at temperatures above 300° C. A high temperature epoxy may be characterized by a relatively greater extent of cross-linking and molecular weight when compared to lower temperature epoxies. Pure form refers to the situation where the epoxy is cured without the presence of additives such as cellulose micro or nanocrystals. Pure form is achieved when the epoxy is mixed and cured by combining only the minimum required components, and in one case the minimum required components are the first and the second part. One example of a suitable epoxy is the end product of the reaction between a mixture of AREMCO-BOND™ 526-N-A and 526-N-B, namely aliphatic amine, 1,2,3,6-tetrahydro-methyl-3,6-methano-phthalicanhydride, epichlorohydein and phenol formaldehyde novolac. A commercially available novolac epoxy adhesive may be used. A novolac includes a phenol-formaldehyde resin with a formaldehyde to phenol molar ratio of less than one. The composite adhesive, for example the cured end product of epoxy (or other suitable adhesive) and cellulose micro or nanocrystals, may degrade at a lower temperature than a corresponding adhesive in pure form—one that does not contain the cellulose micro or nanocrystals. A suitable epoxy may include any epoxy as long as the epoxy degrades at a higher minimum temperature than the cellulose micro or nanocrystals do.

A cured adhesive, such as an epoxy, may form a covalently linked polymer matrix or network. The cellulose micro or nanocrystals may cooperate with the epoxy to form the polymer matrix. In some cases, the cellulose micro or nanocrystals react with the epoxy starting materials to form links in the polymer matrix, for example one or more of cross-links between chains, and links in the chains themselves. Linking may be achieved via reactions between the alcohol (or functionalized) moieties on the cellulose micro or nanocrystals, and one or both the epoxide and hardener. In some embodiments, cellulosic materials such as cellulose micro and/or nanocrystals may act as a weak hardener for epoxies, as cellulose materials such as CNCs have surface OH groups. These are less reactive than the NH2 groups normally found in epoxy hardeners, but they may still react to crosslink the epoxy.

In some embodiments, degradation may be achieved by breaking the links within the adhesive matrix, for example by cleavage of covalent bonds that are one or more of a) internal to the cellulose micro or nanocrystals or b) at the interface between the cellulose micro or nanocrystals and the epoxy in the polymer matrix. In some cases, degradation may occur by the breaking of non-covalent forces, such as intermolecular forces or van der Waals forces. The polymer matrix may be comprised of long chain polymer chains that interact with one another via van der Waals forces. In some cases, the polymer chains are comprised of chain links that are covalently bonded to form links in a chain. In other cases, the polymer matrix is comprised of long polymer chains that are cross-linked together via covalent linkages to form a dense, highly ordered structure. In further cases, the matrix is comprised of both chain-linking and cross-linking polymer chains. Cleavage of chain links or cross-links may lead to a decrease in the adhesive properties of the composition and degradation. By contrast, without thermal degradation of the epoxy, or without addition of cellulose micro or nanocrystals into the epoxy, the crosslinked matrix may be insoluble and infusible, and relatively difficult to remove post-application without damaging the underlying substrate.

Referring to FIG. 1, a method is illustrated of securing adjacent parts together with the composition 10. Initially, to secure the parts 12, 14 together, the composition 10 may be applied in an uncured or partially cured state on one or both respective contact surfaces 22 and 24 of parts 12, 14. The parts 12, 14 may then be placed in sufficient proximity to permit the composition 10 to bind the surfaces 22, 24 together, for example by formation of a polymer matrix, effectively adhering the parts together.

Referring to FIG. 1, a method is also illustrated of heating the degradable composition 10 to a temperature sufficient to degrade the adhesive and separate the adjacent parts. After heating, and in some cases after cooling to a sufficiently low temperature such as room temperature, the parts 12, 14 may be separated from one another and the adhesive removed from the adjacent parts via a suitable method, such as scraping by a tool 30. Once degraded at high heat and cooled, for example to a temperature between 0° C. and 50° C., or to about room temperature or to the same temperature (for example ambient temperature) that the parts had prior to heating, composition 32 may have a brittle appearance and texture, and may be relatively easy to remove from the contact surfaces 22, 24. Heating the composition may comprise heating to a maximum temperature of less than 300° C. to degrade the adhesive. In some cases, heating may comprise heating to a maximum temperature of 250° C. or less or a maximum of 220° C. or less. Separation may also be carried out at relatively high temperatures above room temperature, although cooling to room temperature has been found to result in the CNC epoxy being relatively easier to remove from the substrate.

One application of the disclosed thermally degradable adhesives is in the oil & gas and mining industries. Referring to FIG. 1, the composition may secure a plurality of parts 12, 14 together, with the parts 12, 14 forming part of a downhole apparatus. For example, the composition may be applied at a rod joint, tubing joint, or another joint between adjacent downhole tools or between a downhole tool and a piece of rod or tubing. The downhole apparatus may be provided for use in a drilling, completion, production, stimulation, or other suitable downhole application. In some cases the adhesive is applied to secure parts of a drilling shaft together or secure a downhole tool to a drilling shaft. The adhesive may be tailored to be thermally stable at the temperatures experienced by the downhole tool during use in the well. In some cases, the adhesive is applied and located within a threaded connection 26 between adjacent parts 12, 14 of a downhole tool, such as two lengths of pipe as shown.

When it is desired to separate the parts 12, 14, the downhole apparatus may be removed from the well and heat 28 applied to the connection to degrade the composition and permit the parts to be separated. With a conventional, non-degradable adhesive, the tools may be separated by heating the adhesive above its melting temperature and unthreading while the melted adhesive is still in a heated, liquid, semi-liquid, or pliable state. In some cases, the conventional adhesives require heating to temperatures of more than 300° C. At such relatively high temperatures, the tools may crack or warp as a result of the high temperature itself, and/or as a result of relatively high temperature heating followed by relatively fast or uncontrolled cooling. As well, because the adhesive is not itself degraded, once the parts are separated the adhesive forms a gummy residue that must be scraped off, potentially damaging the threads in the scraping process due to the forces required to remove the residue. By contrast, a thermally degradable adhesive may be tailored to degrade at relatively lower temperatures than conventional adhesives, and thus reduce the potential of tool damage. In some cases, separation, in the methods disclosed here, is carried out after heating 28 and cooling 29 of the adjacent parts and adhesive, thus providing a relatively more streamlined and safer process that may be less likely to damage the tool than conventional methods. The cooling step 29 may be carried out following a gradual cooling profile that reduces or minimizes thermal shock to the parts 12, 14. Cooling may be carried out to ambient or room temperature. A thermally degradable adhesive may also change composition upon degradation, in some cases forming a brittle powder, which is easier to remove from the contact surfaces of the parts than would a melted, non-degraded adhesive. Such advantages may reduce the man hours, and corresponding cost, required to remove the adhesive and separate the parts. Such advantages may also reduce or prevent damage to the parts, thus lengthening tool life and reducing costs associated with repairing or replacing damaged parts.

Cellulosic materials may be used in the disclosed compositions. Cellulose is the most abundant natural polymer available on the earth and is an important structural component of the cell wall of various plants. Apart from plants, cellulose is also present in a wide variety of living species, such as algae, fungi, bacteria, and even in some sea animals such as tunicates. Cellulose is a fibrous, tough, and water-insoluble polymer and plays an essential role in maintaining the structure of plant cell walls. Moreover, cellulose is a biodegradable, biocompatible, and renewable natural polymer and hence it is considered an alternate to non-degradable fossil fuel-based polymers. The chemical structure of cellulose shows that the polymer, formed by condensation, consists of monomers joined together by glycosidic oxygen bridges. Cellulose may comprise β-1,4-linked glucopyranose units that form a high-molecular-weight linear homopolymer. Each glucopyranose unit bears three hydroxyl groups, which impart cellulose some of the characteristic properties such as hydrophilicity, chirality and biodegradability. The ability of these hydroxyl groups to form strong hydrogen bonds bestows other properties such as multiscale microfibrillated structure, hierarchical organization (crystalline and amorphous fractions), and highly cohesive nature.

Processing cellulose may yield a variety of useful materials, such as micro and nanocrystalline cellulose, also referred to herein as cellulose micro or nanocrystals. Cellulose micro or nanocrystals in this document include the following, including mixtures of more than one type of the following: nanowhiskers, nanocrystalline cellulose (cellulose nanocrystals, a.k.a. CNCs), whiskers, nanoparticles, nanofibers, bacterial nanocellulose (BC), mi crocrystallites, microfibrillated cellulose (MFC), or microcrystalline cellulose. In some cases cellulose nanocrystallines (CNCs) may be used. CNCs may be highly crystalline rod-like particles with a high aspect ratio, high degree of surface area, and considerable stiffness and toughness. CNCs may display high mechanical properties, such as axial elastic modulus close to 220 GPa and high tensile strength (7.5 GPa). CNCs may have high thermal stability and may degrade at temperatures above 250° C. In one case, nanocelluloses such as CNCs are rod shaped fibrils with a diameter less than about 60 nm, in some cases between about 4 nm to about 15 nm, a length of about 150 nm to about 350 nm and a length/diameter ratio of approximately 20 to 200. CNCs of other dimensions may be used.

Cellulose micro or nanocrystals may be derived from cellulose via a suitable method. A suitable starting material includes purified cellulose, which may be provided by disintegrating agricultural biomass, or may be produced by bacterial processes. Cellulose may be further processed into nanocellulose via a suitable method. In a first method, nanocellulose can be prepared from the chemical pulp of wood or agricultural fiber mainly by acid hydrolysis to remove the amorphous regions, which then produce nano-size fibrils. In the final stage, individual whiskers or crystallites may be produced and stabilized in aqueous suspensions by either sonicating or passing through a high shear micro fluidizer.

The second method is primarily a physical treatment, wherein bundles of microfibrils, called cellulose microfibril or microfibrillated cellulose, with diameters from tens of nanometers (nm) to micrometers (μm) may be generated by using high pressure homogenizing and grinding treatments. A process using high-intensity ultrasonication may also be used to isolate fibrils from natural cellulose fibres. High intensity ultrasound may produce strong mechanical oscillating power, so the separation of cellulose fibrils from biomass is possible by the action of hydrodynamic forces of ultrasound. Such a method may produce a microfibrillated cellulose with a diameter less than about 60 nm, more preferably between about 4 nm to about 15 nm, and a length less than 1 μm. The microfibrillated cellulose may further undergo chemical, enzymatic and/or mechanical treatment.

Cellulose micro or nanocrystals may be functionalized for use in the compositions disclosed herein. In some cases, the superficial hydroxyl moieties are modified to a different functional group, such as an amine. Modified cellulose micro or nanocrystals may act as a hardener for the adhesive, and may improve reactivity with the adhesive. The cellulose micro or nanocrystals may be modified to incorporate epoxide, amino or other suitable functionalities that may react in the same or a similar fashion as the epoxy resin components. For example, the cellulose micro or nanocrystals may be modified to act as polyfunctional hardeners. Functionalities compatible with other adhesives may also be added, such functionalities compatible with polyurethane and acrylate based adhesives. In some cases, either the epoxy resin or hardener may be replaced with the appropriately functionalized cellulose micro or nanocrystals. The cellulose micro or nanocrystals may also be functionalized to tune the degradation threshold temperature. This may be accomplished by increasing or decreasing the potential for forming chain links or cross-links in the polymer matrix to create a more or less dense matrix. Modification of the cellulose micro or nanocrystals may improve adhesion to substrates, such as substrates that are difficult to adhere to, for example steel.

Referring to FIG. 1, the starting materials required to form the cured thermally degradable adhesive may be provided in kit form, for example with instructions 50, for example a paper document or electronic document saved on a computer readable medium. In some cases the starting material is provided in independent and discrete parts, such as when a two part epoxy formulation is provided. The cellulose micro or nanocrystals may be provided as an independent third part or pre-mixed in one or all starting materials. For example, a two part epoxy may be provided with cellulose micro or nanocrystals dispersed in the one of the two parts that contains hardener, or the cellulose micro or nanocrystals may be provided in a third part that is then pre-mixed with one or both of the first and second parts prior to curing.

Suitable non-epoxy adhesives may be used, for example toughened acrylics, acrylate based adhesives, nitrocellulose, cyanoacrylates, anaerobics, phenolics, polyvinyl acetates, polyurethanes, pressure-sensitive adhesives, hot adhesives, elastomers, thermoplastics, emulsions, and thermosets, natural adhesives, bioadhesives, contact adhesives, drying adhesives, synthetic adhesives, and others, including combinations of different adhesives. CNCs and cellulosic materials are expected to form thermally degradable compositions when distributed in any type of adhesive because degradability is believed to be due to the internal structure of the cellulosic materials, which all share the same internal chemical structure, and such structure is preserved whether the cellulosic material is incorporated covalently into a polymer or freely distributed in a solid mixture.

Testing

The combination of CNCs and adhesives, such as epoxy, may be referred to as CNC-adhesive nanocomposites, for example a CNC-epoxy nanocomposite. The thermal and mechanical properties of CNC-epoxy nanocomposites were tested and characterized as a function of temperature. In these tests, the epoxy hardener and resin (AREMCO-BOND™ 526-N-A, and 526-N-B) were purchased from Aremco Products Inc. The ingredients of 526-N-A hardener are aliphatic amine and 1,2,3,6-tetrahydro-methyl-3,6-methano-phthalicanhydride, and the ingredients of 526-N-B are a polymer of epichlorohydein and phenol formaldehyde novolac, based on the material safety data sheet provided by the company. The CNC material used was provided from Alberta Innovates Technology Futures.

Lap shear (tensile) testing was performed in accordance to ASTM D 1002 Standard, “Apparent Shear Strength of Single-Lap-Joint Adhesively Bonded Metal Specimens by Tension Loading (Metal to Metal Bonding)”, to evaluate the bond strength, before and after heating, of CNC-epoxy adhesives. Referring to FIGS. 1A and 1B, the testing specimen was created using two steel panels 40 and 42; which were prepared from a 1.6 mm thick steel plate. The steel plates were 92 mm long and 25 mm wide with a 12 mm overlap for adhesive 10. Opposing ends of the steel plates had a 15 mm long area 41 for the test grips.

Epoxy resin and hardener were mixed at ratio of 1:1 at room temperature. The desired amount of CNCs was added and hand-stirred for 5 min until a paste-like mixture was obtained. The CNC was also added directly to the hardener, and the resulting mixture was added to the epoxy. The CNC and epoxy adhesive was painted onto the coupon test surface with a specific area, which was then overlapped and clamped with clips. The specimens were cured at 90° C. for 2 h and at 150° C. for 8 h according to the cure schedule on the data sheet. Composite specimens were then evaluated for thermal degradation by heating to a maximum temperature, such as 250° C., and then testing the shear strength. If the shear strength was lower after heating to the maximum temperature when compared to the unheated control, it was determined that the adhesive had been degraded.

An Instron 5967 testing system (Instron, Canton, Mass., USA) was used to measure the tensile shear strength. The two coupons were clamped vertically and pulled 180° at a constant rate of 1 mm/min. The pulling force was increased until the adhesive joint failed. The tensile shear strength was then calculated from the maximum load force using the following formula:

lap shear strength=maximum load force/bond area

The adhesive strength of neat (pure) epoxy and CNC-epoxy was assessed by lap shear testing in accordance to ASTM D 1002 Standard as above. The loading forces were tested on neat epoxy adhesive specimens with or without a baking step at 250° C.

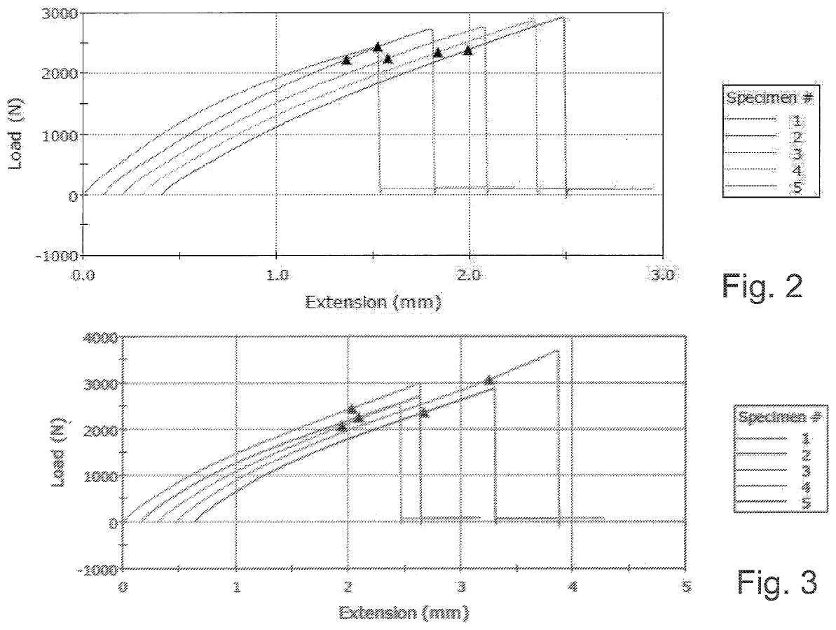

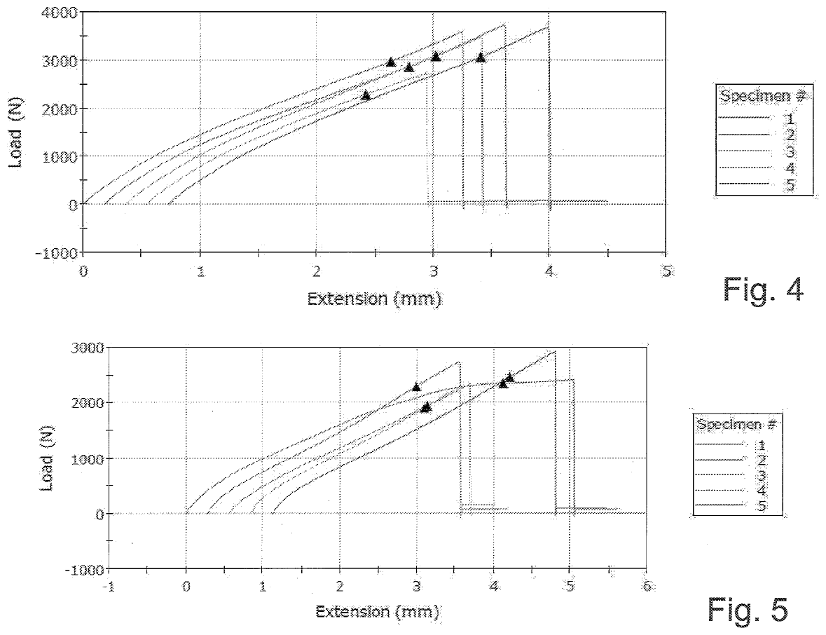

Control groups. The shear strength of three groups (A, B, & C) of specimen containing neat Epoxy 526 were tested, group A was cured at 90° C. for 1 h and 150° C. for 8 h, group B was cured at 90° C. for 1 h and 150° C. for 8 h and baked at 200° C. for another 1 h, and group C was cured at 90° C. for 1 h, 150° C. for 8 h and then baked at 250° C. for another 1 h. The results showed that the average failure pulling force for pure Epoxy 526 specimens without baking=2744 N (group A, FIG. 2) and with baking at 250° C.=3432 N (group C, FIG. 4). For group A, failure pulling forces ranged from 2500-3000 N with extensions at failure of between 1.5 and 2.5 mm (FIG. 2). For group B, failure pulling forces ranged from 2500-3600 N with extensions at failure of between 2.5 and 3.9 mm (FIG. 3). For group C, failure pulling forces ranged from 2500-3500 N with extensions at failure of between 3 and 4 mm (FIG. 4). Tables 1-4 below detail some further test data on the groups A and C specimens.

TABLE 1
Further test data on group A specimens

| | Tensile | Extension | Load at | Tensile |
|---|---|---|---|---|
| | stress | at Tensile | Tensile | extension |
| | at Tensile | Strength | Strength | at Tensile |
| Specimen | Strength (MPa) | (mm) | (N) | Strength (mm) |
| 1 | 3.59899 | 1.52036 | 2432.91527 | 1.52036 |
| 2 | 3.29486 | 1.25732 | 2227.32812 | 1.25732 |
| 3 | 3.32131 | 1.37089 | 2245.20743 | 1.37089 |
| 4 | 3.46691 | 1.52946 | 2343.63079 | 1.52946 |
| 5 | 3.52355 | 1.58308 | 2381.91694 | 1.58308 |

TABLE 2
Further test data on group A specimens

| | Tensile strain | True stress | True strain |
|---|---|---|---|
| | at Tensile | at Tensile | at Tensile |
| Specimen | Strength (mm/mm) | Strength (Pa) | Strength (mm/mm) |
| 1 | 0.05848 | 3809438.84427 | 0.05683 |
| 2 | 0.04836 | 3454198.83248 | 0.04723 |
| 3 | 0.05273 | 3496434.45713 | 0.05138 |
| 4 | 0.05883 | 3670852.31421 | 0.05716 |
| 5 | 0.06089 | 3738086.38904 | 0.05911 |

TABLE 3
Further test data on group C specimens

| | Tensile | Extension | Load at | Tensile |
|---|---|---|---|---|
| | stress | at Tensile | Tensile | extension |
| | at Tensile | Strength | Strength | at Tensile |
| Specimen | Strength (MPa) | (mm) | (N) | Strength (mm) |
| 1 | 4.38430 | 2.63411 | 2963.78404 | 2.63411 |
| 2 | 4.55875 | 2.83772 | 3081.71600 | 2.83772 |
| 3 | 4.22387 | 2.42804 | 2855.33428 | 2.42804 |
| 4 | 3.38156 | 1.87629 | 2285.93230 | 1.87629 |
| 5 | 4.52010 | 2.67888 | 3055.58830 | 2.67888 |

TABLE 4
Further test data on group C specimens

| | Tensile strain | True stress | True strain |
|---|---|---|---|
| | at Tensile | at Tensile | at Tensile |
| Specimen | Strength (mm/mm) | Strength (Pa) | Strength (mm/mm) |
| 1 | 0.10131 | 4828476.87829 | 0.09650 |
| 2 | 0.10914 | 5056308.20180 | 0.10359 |
| 3 | 0.09339 | 4618317.29549 | 0.08928 |
| 4 | 0.07217 | 3625587.28546 | 0.06968 |
| 5 | 0.10303 | 4985825.13699 | 0.09806 |

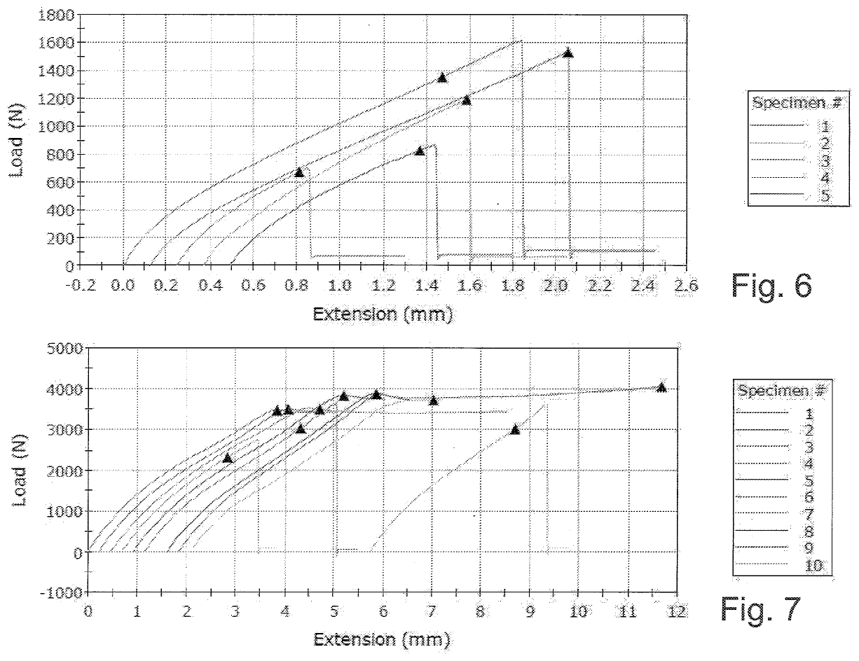

5% CNC-epoxy groups. Testing results for 5% CNC-epoxy composite specimens were also obtained. The shear strength of two groups (D & E) of specimen of Epoxy 526 containing 5% wt. CNC was tested. Group D was cured at 90° C. for 1 h and 150° C. for 8 h and group E were cured at 90° C. for 1 h, 150° C. for 8 h and then baked at 250° C. for another 1 h. Baking the 5% CNC-epoxy composite specimen group E caused a decrease in shear strength relative to the unbaked 5% CNC-epoxy composite specimen group D. By contrast, baking pure epoxy specimen group C caused an increase in shear strength relative to the unbaked pure epoxy specimen group A. The failure pulling force for CNC-epoxy (5% wt.) specimens (group D) without baking was 2528 N (FIG. 5), while the failure pulling force was reduced to 1180 N after the baking step (group E, FIG. 6). For group D, failure pulling forces ranged from 2100-3000 N with extensions at failure of between 3.5 and 5 mm (FIG. 5). For group E, failure pulling forces ranged from 750-1600 N with extensions at failure of between 0.8 and 2.1 mm (FIG. 6). Tables 5-8 below detail some further test data on the groups D and E specimens.

TABLE 5
Further test data on group D specimens

| | Tensile | Extension | Load at | Tensile |
|---|---|---|---|---|
| | stress | at Tensile | Tensile | extension |
| | at Tensile | Strength | Strength | at Tensile |
| Specimen | Strength (MPa) | (mm) | (N) | Strength (mm) |
| 1 | 3.46847 | 4.12022 | 2344.68281 | 4.12022 |
| 2 | 3.38564 | 2.71071 | 2288.69125 | 2.71071 |
| 3 | 2.87202 | 2.57652 | 1941.48377 | 2.57652 |
| 4 | 2.81468 | 2.25219 | 1902.72301 | 2.25219 |
| 5 | 3.63048 | 3.08196 | 2454.20620 | 3.08196 |

TABLE 6
Further test data on group D specimens

| | Tensile strain | True stress | True strain |
|---|---|---|---|
| | at Tensile | at Tensile | at Tensile |
| Specimen | Strength (mm/mm) | Strength (Pa) | Strength (mm/mm) |
| 1 | 0.15847 | 4018113.89260 | 0.14710 |
| 2 | 0.10426 | 3738618.60841 | 0.09917 |
| 3 | 0.09910 | 3156625.26438 | 0.09449 |
| 4 | 0.08662 | 3058493.82131 | 0.08307 |
| 5 | 0.11854 | 4060829.36418 | 0.11202 |

TABLE 7
Further test data on group E specimens

| | Tensile | Extension | Load at | Tensile |
|---|---|---|---|---|
| | stress | at Tensile | Tensile | extension |
| | at Tensile | Strength | Strength | at Tensile |
| Specimen | Strength (MPa) | (mm) | (N) | Strength (mm) |
| 1 | 2.00111 | 1.46955 | 1352.75006 | 1.46955 |
| 2 | 2.26577 | 1.92719 | 1531.66130 | 1.92719 |
| 3 | 0.99841 | 0.56388 | 674.92694 | 0.56388 |
| 4 | 1.76636 | 1.21317 | 1194.06261 | 1.21317 |
| 5 | 1.22915 | 0.87527 | 830.90499 | 0.87527 |

TABLE 8
Further test data on group E specimens

| | Tensile strain | True stress | True strain |
|---|---|---|---|
| | at Tensile | at Tensile | at Tensile |
| | Strength (mm/mm) | Strength (Pa) | Strength (mm/mm) |
| 1 | 0.05652 | 2114214.86186 | 0.05498 |
| 2 | 0.07412 | 2433715.99501 | 0.07150 |
| 3 | 0.02169 | 1020066.04599 | 0.02146 |
| 4 | 0.04666 | 1848784.04068 | 0.04560 |
| 5 | 0.03366 | 1270527.66193 | 0.03311 |

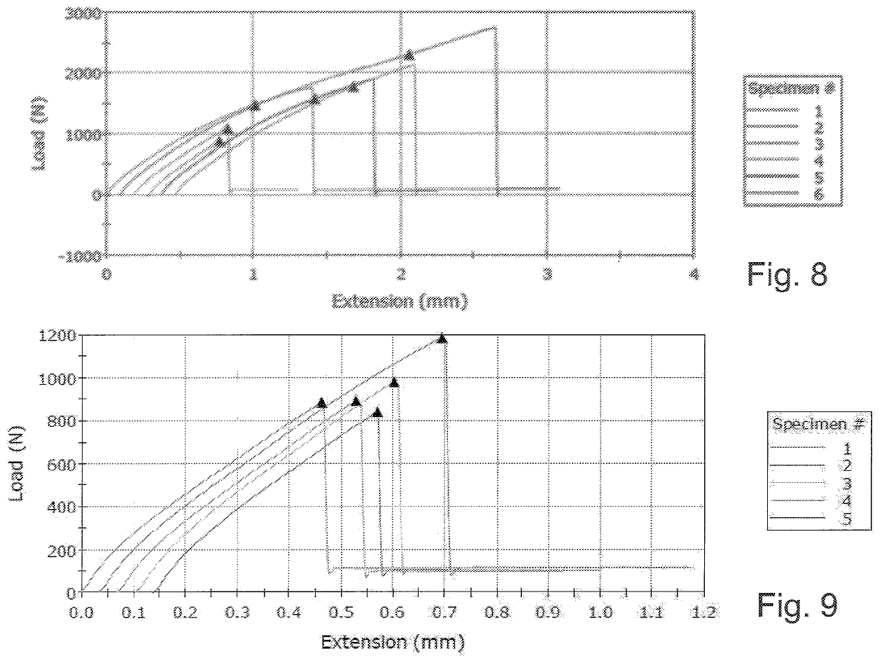

50% CNC-epoxy groups. The shear strength of three groups (F, G, and H) of specimen of Epoxy 526 containing 50% wt. CNC was also tested. Group F was cured at 90° C. for 1 h and 150° C. for 8 h, Group G was cured at 90° C. for 1 h and 150° C. for 8 h and then baked at 200° C. for another 1 h, and Group H was cured at 90° C. for 1 h and 150° C. for 8 h and then baked at 250° C. for another 1 h. Baking to 250° C. reduced the failure pulling force for CNC-epoxy (50% wt.) from 4478 N (group F, no baking, FIG. 7) to 955 N (group H, FIG. 9). Thus, the addition of CNC into epoxy was found to lead to thermal degradability of the resulting composite. For group F, failure pulling forces ranged from 2600-4000 N with extensions at failure of between 3.3 and 9.5 mm (FIG. 7). For group G, failure pulling forces ranged from 1000-2800 N with extensions at failure of between 0.8 and 2.7 mm (FIG. 8). For group H, failure pulling forces ranged from 800-1200 N with extensions at failure of between 0.45 and 0.70 mm (FIG. 9). Tables 9-12 below detail some further test data on the groups F and H specimens.

TABLE 9
Further test data on group F specimens

| | Tensile | Extension | Load at | Tensile |
|---|---|---|---|---|
| | stress | at Tensile | Tensile | extension |
| | at Tensile | Strength | Strength | at Tensile |
| | Strength (MPa) | (mm) | (N) | Strength (mm) |
| 1 | 5.13796 | 3.83500 | 3473.26338 | 3.83500 |
| 2 | 5.16615 | 3.82634 | 3492.31571 | 3.82634 |
| 3 | 5.16868 | 4.23629 | 3494.02934 | 4.23629 |
| 4 | 3.43823 | 2.13884 | 2324.24065 | 2.13884 |
| 5 | 5.65888 | 4.26616 | 3825.40584 | 4.26616 |
| 6 | 4.47709 | 3.15531 | 3026.51525 | 3.15531 |
| 7 | 4.45660 | 7.30076 | 3012.66313 | 7.30076 |
| 8 | 5.72238 | 4.24308 | 3868.32803 | 4.24308 |
| 9 | 5.99706 | 9.81866 | 4054.01438 | 9.81866 |
| 10 | 5.49840 | 4.94241 | 3716.91525 | 4.94241 |

TABLE 10
Further test data on group F specimens

| | Tensile strain | True stress | True strain |
|---|---|---|---|
| | at Tensile | at Tensile | at Tensile |
| | Strength (mm/mm) | Strength (Pa) | Strength (mm/mm) |
| 1 | 0.14705 | 5895813.19767 | 0.13759 |
| 2 | 0.14717 | 5926433.39626 | 0.13730 |
| 3 | 0.16293 | 6010838.66328 | 0.15095 |
| 4 | 0.08226 | 3721064.76409 | 0.07905 |
| 5 | 0.16408 | 6587411.59972 | 0.15193 |
| 6 | 0.12136 | 5020425.44341 | 0.11454 |
| 7 | 0.28080 | 5708009.08803 | 0.24748 |
| 8 | 0.16320 | 6656244.65538 | 0.15117 |
| 9 | 0.37764 | 8261798.28018 | 0.32037 |
| 10 | 0.19009 | 6543600.25812 | 0.17403 |

TABLE 11
Further test data on group H specimens

| | Tensile | Extension | Load at | Tensile |
|---|---|---|---|---|
| | stress | at Tensile | Tensile | extension |
| | at Tensile | Strength | Strength | at Tensile |
| | Strength (MPa) | (mm) | (N) | Strength (mm) |
| 1 | 1.30742 | 0.46094 | 883.81499 | 0.46094 |
| 2 | 1.75108 | 0.65835 | 1183.72850 | 0.65835 |
| 3 | 1.31982 | 0.45795 | 892.19615 | 0.45795 |
| 4 | 1.44920 | 0.49714 | 979.66008 | 0.49714 |
| 5 | 1.24224 | 0.43018 | 839.75628 | 0.43018 |

TABLE 12
Further test data on group H specimens

| | Tensile strain | True stress | True strain |
|---|---|---|---|
| | at Tensile | at Tensile | at Tensile |
| | Strength (mm/mm) | Strength (Pa) | Strength (mm/mm) |
| 1 | 0.01773 | 1330597.02118 | 0.01757 |
| 2 | 0.02532 | 1795416.85039 | 0.02501 |
| 3 | 0.01761 | 1343063.14705 | 0.01746 |
| 4 | 0.01912 | 1476911.30300 | 0.01894 |
| 5 | 0.01655 | 1262796.33754 | 0.01641 |

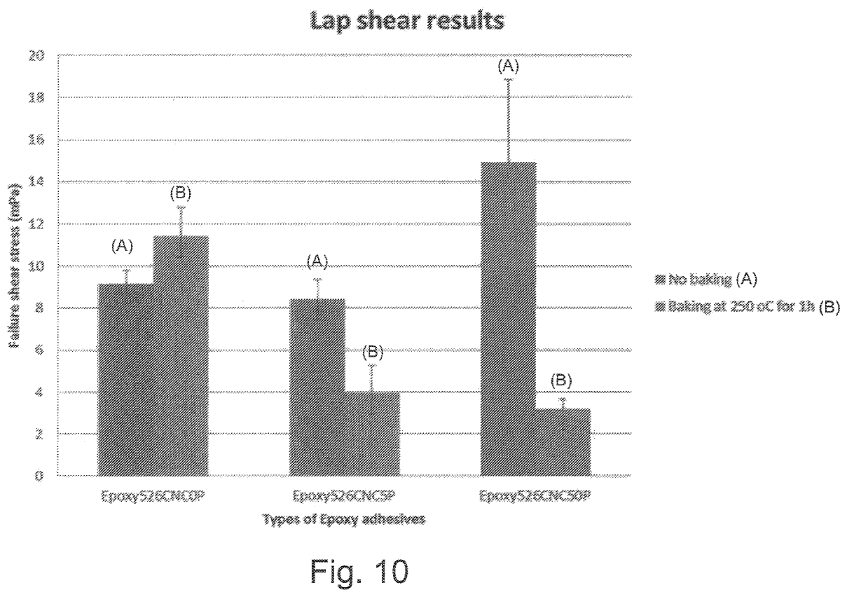

Analysis of lap shear testing. Referring to FIG. 10, the effect of adding CNCs on shear strength of epoxy adhesives was assessed. If after baking more shear stress was needed to cause failure, it was determined that the shear strength of the composite had increased and if after baking the value decreased it was determined that degradation had occurred. For control group A (pure epoxy, no baking), an average failure shear stress value of 9±0.8 mPa was found. By contrast, the average value of shear strength of epoxy adhesive with 5 wt. % CNC (group D, no baking) was found to be 8.5±1 mPa, which is slightly lower than that of pure epoxy (group A). When compared with pure epoxy (group A), CNC-epoxy specimens with 50 wt. % CNC loading (group F, no baking) showed a relatively large increase in shear strength after curing, with an average value of 15±2 mPa. Thermal degradability was also investigated by baking specimen groups C, E and H at 250° C. for 1 hour. An increase in shear strength was found for group C (pure Epoxy) after baking over group A (no baking) with an average failure shear stress value of 11.5±1.2 mPa for group C. Group E (5 wt. % CNC) was found to have an average failure shear stress value of 4±0.5 mPa, which is a decrease from the non-baked group D (5 wt. % CNC). Group H (50 wt. % CNC) also showed a decrease in average failure shear stress value of 3±0.4 mPa after baking relative to Group F. Overall, a decrease in shear strength for CNC-epoxy composite specimens (group E, H) after baking was detected while the pure epoxy (group C) actually showed increased strength after baking.

The adhesive samples demonstrated varying failure modes. Groups A, B, C, D, E, F, G, and H were tested for adhesive or cohesive failure. The mode of failure was ascertained by determining if adhesive remained after the above mentioned shear strength tests. If most or all of the adhesive remained on one of the substrates (but not both) after shearing, then adhesive failure had occurred. An adhesive failure occurs when the adhesive completely loses its bond to the substrate, which means the internal strength of adhesive itself is greater than the bonding force applied on the interface between the adhesive and substrate. When the adhesive strength is less than the bonding force to the substrate, cohesive failure will occur, and the adhesive layer may be pulled apart, leaving portions of adhesive bonded to both substrates. Groups A-F showed adhesive failure while group H (50 wt. % CNC and baked at 250° C.) showed cohesive failure. With group H, relatively high loading of CNCs and the additional baking step appear to have reduced the adhesive strength to less than the bonding force between the steel and epoxy. With the group H sample, it is believed that the relatively high CNC content may have created, or increased the extent of, voids filled with pure CNCs in the epoxy layer. Such voids may weaken the epoxy adhesive layer strength resulting in cohesive failure as evidenced by a metal/epoxy interaction that appeared to be stronger than epoxy/voids/epoxy layers. Thus, it appears that using a relatively higher content of CNCs used increased the possibility that adhesive failure switches to cohesive failure, where there are more failure points within the epoxy than on the metal-epoxy interface.

Compared to pure or neat epoxy, stronger shear strength at room temperature was obtained with 50% weight CNC-epoxy composites. The shear strength of CNC-epoxy is reduced when baked at 250° C. for 1 hour, indicating potential application as thermal degradable adhesives. The residue left behind from the CNC-epoxy composites was brittle, and easy to remove from the substrate, in contrast to the gummy residue left behind by the epoxy alone. Composites disclosed here may have greater strengths relative to pure adhesive at temperatures below the thermal degradation threshold. Weight percentages are based on the total weight of the thermally degradable composition before curing of the adhesive, whether the thermally degradable composition is referred to as a composition or simply as an adhesive.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

What is claimed is:

1. A method comprising:
heating an adhesive, which secures adjacent parts together and contains one or both of cellulose micro or nanocrystals, to a temperature sufficient to degrade the adhesive; and separating the adjacent parts.

2. The method of claim 1 further comprising allowing the adhesive to cool to a temperature between 0 and 50° C. prior to separating the adjacent parts.

3. (canceled)

4. The method of claim 1 in which the adhesive comprises cellulose nanocrystals (CNCs).

5. The method of claim 1 in which the cellulose micro or nanocrystals have a concentration of at least fifteen percent by weight of the adhesive.

6. (canceled)

7. The method of claim 1 in which heating comprises heating to a maximum temperature of less than 300° C. to degrade the adhesive.

8. (canceled)

9. The method of claim 1 in which heating comprises heating to a temperature between 200° C. and 300° C. to degrade the adhesive.

10. (canceled)

11. The method of claim 1 in which the adhesive comprises an epoxy.

12. The method of claim 11 in which the epoxy is an end product of a two part polymerizable system comprising a first part containing epoxides and a second part comprising a hardener.

13. (canceled)

14. The method of claim 11 in which the epoxy is stable at temperatures of 200° C. or higher when cured in pure form.

15. The method of claim 14 in which the epoxy comprises the end product of reaction between a mixture of aliphatic amine, 1,2,3,6-tetrahydro-methyl-3,6-methano-phthalicanhydride, epichlorohydein and phenol formaldehyde novolac.

16. The method of claim 1:
wherein prior to heating, the adhesive and the cellulose micro or nanocrystals form a polymer matrix where the cellulose micro or nanocrystals form links in the polymer matrix; and
wherein heating is carried out to an extent sufficient to break the links, by cleavage of covalent bonds i) internal to the cellulose micro or nanocrystals or ii) at the interface between the cellulose micro or nanocrystals and the adhesive in the polymer matrix.

17. (canceled)

18. (canceled)

19. The method of claim 1 in which prior to heating, the adhesive is located within a threaded connection between adjacent parts.

20. (canceled)

21. The method of claim 1 in which the cellulose micro or nanocrystals comprise one or more of nanowhiskers, nanocrystalline cellulose, whiskers, nanoparticles, nanofibers, microcrystallites, or microcrystalline cellulose.

22. A thermally degradable composition comprising: an adhesive; and one or both of cellulose micro or nanocrystals, wherein the cellulose micro or nanocrystals have a concentration of above 30% by weight of the thermally degradable composition.

23. The thermally degradable composition of claim 22 in which the adhesive comprises cellulose nanocrystals (CNCs).

24. (canceled)

25. (canceled)

26. The thermally degradable composition of claim 22 in which the thermally degradable composition degrades at temperatures of less than 300° C.

27. (canceled)

28. (canceled)

29. (canceled)

30. The thermally degradable composition of claim 22 in which the adhesive comprises an epoxy that is an end product of a two part polymerizable system comprising a first part containing epoxides and a second part comprising a hardener.

31. A combination of claim 22 comprising the thermally degradable composition securing adjacent parts.

32. (canceled)

33. The thermally degradable composition of claim 22 in which the cellulose micro or nanocrystals comprise one or more of nanowhiskers, nanocrystalline cellulose, whiskers, nanoparticles, nanofibers, microcrystallites, or microcrystalline cellulose.

34. (canceled)

35. (canceled)

36. (canceled)

37. (canceled)

38. A kit comprising:
a first part of an epoxy adhesive comprising an epoxide;
a second part of an epoxide adhesive comprising a hardener;
cellulose microcrystals, cellulose nanocrystals, or both; and
a written matter describing instructions for combining the first and second parts to form an epoxy adhesive and further describing instructions for degrading the formed epoxy adhesive by heating to a temperature between 200° C. and 300° C.;
wherein the first and second parts of the epoxy adhesive are separate, and wherein the cellulose microcrystals, cellulose nanocrystals, or both, are a) separate from the first and second parts of the epoxy adhesive, orb) dispersed within the first and/or second parts of the epoxy adhesive.

39. (canceled)

40. (canceled)

41. (canceled)
